(19) United States
(12) Patent Application Publication
(10) Pub. No.: US 2015/0093488 A1
(43) Pub. Date: Apr. 2, 2015

(54) DEVICE FOR FORMING PORTIONS OF FOOD IN MULTIPLE RECEPTACLES

(71) Applicants: Michael Gutmann, Leverkusen (DE); Petra Groneberg-Nienstedt, Düsseldorf (DE)

(72) Inventors: Michael Gutmann, Leverkusen (DE); Petra Groneberg-Nienstedt, Düsseldorf (DE)

(73) Assignee: NIENSTEDT GMBH, Haltern am See (DE)

(21) Appl. No.: 14/384,415

(22) PCT Filed: Mar. 12, 2012
(86) PCT No.: PCT/EP2012/054229

§ 371 Date: Sep. 11, 2014

(51) Int. Cl. B30B 15/00; B30B 9/28; A23P 1/10; B30B 12/00

(52) U.S. Cl. CPC B30B 15/0052; B30B 12/00; B30B 9/28; A23P 1/105
USPC 426/531; 100/269.14; 100/269.16; 100/221; 100/35

(57) ABSTRACT

A device for forming portions of food is proposed, comprising a hydraulic press. rne press has at least one hydraulic pressure generator and at least two actuators, wherein each of the actuators comprises a working cylinder and the working cylinders are hydraulically connected. It is preferably provided that a die has at least two separate receptacles for receiving portions of food. The receptacles interact with respective pressing tools, and the pressing tools can in each case be moved by means of an actuator, in particular by means of a pressing ram.

### TECHNICAL FIELD

The invention relates to a device for forming portions of food in multiple receptacles as well as to a corresponding method.

### STATE OF THE ART

Devices for forming portions of food in different shapes are known from WO 2007/096363 A1. The latter describes a method for producing formed portions of meat from whole pieces of natural meat.

In the case of the methods known from the state of the art, uneven sized portions of food are on principle introduced into the shape press. Certain weight tolerances in response to the portioning of the food are also common. In response to the pressing, it may thus happen that the molds, into which the portions of food are to be molded, are not filled completely.

### DESCRIPTION OF THE INVENTION

It is thus the object of the invention to provide an improved forming device and a method for forming a portion of food.

The object is solved according to the invention by means of a device for forming portions of food according to claim 1 as well as by means of a method according to claim 6.

A device for forming portions of food is proposed, comprising a fluid power press. The press has at least one fluid power pressure generator as well as at least two actuators, wherein the actuators in each case comprise a working cylinder and wherein the working cylinders are connected by fluid power. Preferably, provision is made for a die to have at least two separate receptacles for receiving portions of food. The receptacles in each case interact with a pressing tool, wherein the pressing tools can in each case be moved by means of an actuator, in particular by means of a pressing ram.

In terms of the invention, all methods, in which energy is transferred by the flow of gases or fluids, in particular hydraulics and pneumatics, are to be understood as being fluid technology.

It is the advantage of the proposed device that the portions of food are pressed evenly and gently. The pressing tools are first placed onto the portions of food, in particular in the case of portions of food, which have different heights, when they are introduced into the mold. When a first pressing tool meets a portion of food before further pressing tools are able to act on further portions of food, a pressure compensation occurs between the working cylinders via the hydraulic connection. The counter pressure from the portion of food has the effect that a hydraulic means, which is first conveyed by a pressure generator, is pumped into the remaining working cylinders via the hydraulic connection, until the same pressure has adjusted in all of the working cylinders. All of the portions of food are formed with the same pressure in this manner.

It goes without saying that an identical pressure does not prevail in the working cylinders, in particular due to the resistances in the lines between the working cylinders during the shape forming. Due to the pressure compensation during the forming, a compensation, however, can be responded to even in response to a sudden resistance change, for example due to the composition of the portion of food, in particular without requiring extensive control mechanisms.

Portions of food are, for example, vegetables, starch-containing products, such as potatoes or rice, meat, fish and/or sweet goods. Preferably, the portions of food are frozen, in particular to a temperature of approximately −20° C. to approximately −5° C.

Insofar as the term “approximately” is used in the instant invention, this term specifies a tolerance range, which the person of skill in the art in the instant field considers to be common. In particular, a tolerance range of up to ±20%, preferably of up to ±10%, is to be understood by the term “approximately”.

The pressure generator is preferably embodied as hydraulic pump. In a further embodiment, the pressure generator has a piston, which is driven electromechanically, for example.

The actuators have hydraulic working cylinders comprising working pistons. The working pistons are connected to the pressing tool via a pressing ram. The pressing tool is guided or pressed, respectively, in a receptacle, which encompasses a die. Preferably, one receptacle for each pressing tool is in each case located in the die. Provision is made in a further embodiment for multiple or all of the pressing tools to be guided in one receptacle, in particular when the portions are stamped out by means of the pressing tools. Provision can also be made for multiple dies. In particular, the dies are embodied so as to be exchangeable.

Multiple portions can be pressed in one step by means of the forming device. Provision is preferably made for two to ten pressing rams, which in particular in each case form a portion of food. Due to the fact that the pressing rams in each case exert the same pressure on the portions of food, a constant quality of the formed portions of food is ensured.

According to an embodiment, the device has a regulating unit. The regulating unit controls or regulates the forming device via an open or closed loops. In the context of the invention, the term “controller” identifies open as well as closed loops.

Provision is made in an embodiment for the hydraulic flow in a working cylinder or between the working cylinders, respectively, to be capable of being controlled or regulated by means of at least one valve. In particular, the hydraulic flow can be interrupted. Provision is made, for example, for the hydraulic connection between the working valves to be interrupted. Provision is thus made in an embodiment for a valve, which can prevent the hydraulic flow. Provision is made in a further embodiment for at least one throttle, which can preferably be activated, to define the flow of hydraulic fluid between the working cylinders.

The prevention or throttling of the hydraulic communication between the working cylinders can be used, for example, to move the pressing tools into the receptacle independent from one another. For example, a path control or a pressure control is possible, which is practiced up to a defined movement point and/or a defined pressure rise. After exceeding a threshold value, the hydraulic communication between the working cylinders is then released. This allows for a large number of cycles, because the pressure compensation between the working cylinders takes place only at the end of the forming process and because the press can be moved very quickly until the threshold value is reached.

Provision is made in a preferred embodiment for the device to have at least one flow sensor, by means of which a hydraulic flow from and to a working cylinder can be determined. Provision is preferably made for a flow sensor, by means of which a flow between the working cylinders can be determined. The flow to a working cylinder or between the working cylinders can provide information about the resistance caused by the portion of food. It can also be determined, whether all of the pressing tools move into the receptacles with the same pressure. Unexpected flows or progressions of flow, respectively, for a period of time can signify malfunctions, for example. For example, it can be detected in this manner, whether a receptacle was not filled or whether parts, for example bones or machine parts, which are not provided for the portioning or shape forming, respectively, are arranged in the receptacle.

Provision is made in a further embodiment of the forming device for the pressing tools to be capable of being connected mechanically. Provision is made in particular for a preferably reversible power transmission device between the pressing tools or parts connected thereto. For example, the forming device can be designed such that the pressing tools are locked in place relative to one another, preferably in the initial position. When the press is activated, the pressing tools move together in the direction of the receptacles and, if applicable, at least partially into them. At a defined movement point, provision is made for a release mechanism, which releases the mechanical connection between the pressing tools. The pressing tools can then be connected or are connected via the communicating working cylinders. This embodiments provides for a path control, which is located upstream of the pressure control with communicating working cylinders without high technical effort.

A method is furthermore proposed for forming portions of food by means of a forming device, which is in particular described above, wherein
at least two portions of food are in each case introduced into a receptacle of a die,
at least one pressing tool for each receptacle of the die is in each case placed onto the portion of food,
the force of the pressing tool on the portions of food is increased such that all of the pressing tools exert the same pressure on the respective portions of food.

Preferably, the working cylinders, which operate the pressing tools, are connected hydraulically.

In an embodiment, the deformation of the portions of food is ended, when all of the portions of food in the die have reached the desired deformation. Preferably, the pressing tools move upwards, when they have exerted a certain maximum pressure on the portions of food for a certain period of time. The maximum pressure is determined in the hydraulic system of the press, for example. Provision is made for different maximum pressures and pressing times for different food and portion sizes. In particular, the pressure measurement is combined with a determination of the travel of the pressing rams, in particular of each individual pressing ram.

It is the advantage of the proposed method that an incomplete deformation of the portions of food is prevented. It is in particular the goal in response to the food forming to completely fill the receptacle at least in the extensions perpendicular to the pressing direction. In the case of the methods, which are known from the state of the art, it happens often that the receiving mold is not filled completely in the case of portioning, which is too small or the weight of which is too low, respectively—but which still lies within the tolerance range of the respective product. The desired shape, which appears natural for the most part, is thus not attained. The product often looks as if it has been bitten into. In the case of the method and devices, which are known from the state of the art, portions, which are too large, or portions comprising a weight, which is too large, analogously also lead to problems with the shaping. In contrast, small portions of food, which, in addition to larger portions of food, are arranged in the die, in particular in different receptacles, are also pressed safely into the desired shape by means of the proposed method. The proposed method now allows for a large tolerance range of the masses and/or of the dimensions of the portions of food, which are to be processed simultaneously in one process step of the press. At the same time, only one pressure generator is required, which drives all of the actuators of the press.

An alternative of the method provides for the pressing tools to move a defined amount towards the die or to move a defined amount into the receptacles, before the working cylinders are connected hydraulically. Provision is preferably made for a path control, which is connected upstream of the pressure compensation in the working cylinders. Provision is made in a further embodiment for the working cylinders to be activated such that they shake at a certain point in time, that is, they knock the portion of food into the receptacle by means of a beating movement by means of the pressing tools. Provision is made in a further embodiment for the press to be activated such that the pressing tools amass the portion of food into the mold. In terms of the invention “amassing” is understood as a rotary, sweeping and/or undulated movement of the pressing tools in contact with the portion of food.

Provision is made in a further alternative for the pressing tools to be connected mechanically. Preferably, the mechanical connection between the pressing tools is released when the pressing tools move across a defined point. Provision is made in the alternative or in addition in an embodiment for the communication of the working cylinders to be interrupted or throttled at least temporarily. For example, the pressing rams can be moved into the receptacles independent from one another and the communication between the working cylinders can be released only in a final step, for example, which takes place before the pressing tools move up again. The pressing tools move up again, that is, into their rest position, in particular when all of the pressing tools have covered a certain path into the receptacles, have reached a certain distance power for a certain amount of time and/or when a certain threshold value of the flow has been fallen below or exceeded in the hydraulic system of the device.

Provision is made in particular for a hydraulic flow into the working cylinders and/or between the working cylinders to be regulated as a function of at least one operating parameter of the pressing device. The regulation of the hydraulic flow in particular comprises a switching of the valves, which controls the communication between the working cylinders. The relevant operating parameters can be a travel of the pressing rams, a pressure at at least one location of the hydraulic system and/or a flow of hydraulic means at at least one location in the hydraulic system, for example.

Furthermore, a portion of food is proposed, which is produced or formed, respectively, by means of the above-described method.

### BRIEF DESCRIPTION OF THE DRAWINGS

A further advantageous embodiment follows from the drawing below. The further development illustrated therein, however, should not be interpreted as being limiting. Instead, the features described therein could be combined with the above-described features to form further embodiments. Reference is furthermore made to the fact that the reference numerals specified in the description of the figures do not limit the scope of protection of the instant invention, but only refer to the exemplary embodiments shown in the figures.

FIG. 1 shows a schematic design of a forming device.

### BEST MODE FOR CARRYING OUT THE INVENTION

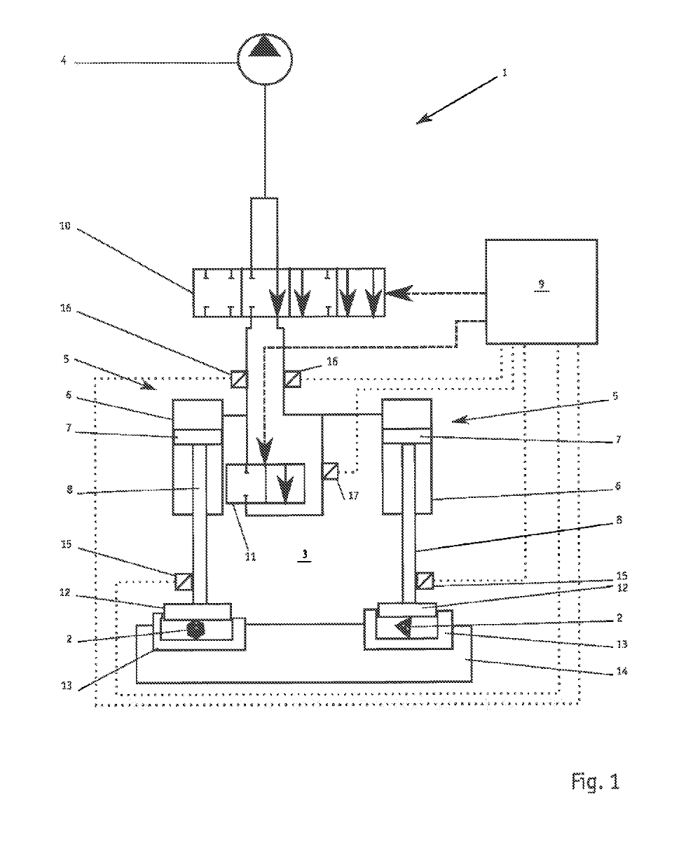

FIG. 1 shows a schematic design of a device 1 for forming portions of food 2. The device 1 has a press 3. The press 3 comprises a pressure generator 4, which is embodied as hydraulic pump in the illustrated embodiment. The press 3 furthermore comprises at least two actuators 5, which have a working cylinder 6, a piston 7 as well as a pressing ram 8. The device 1 furthermore comprises a controller 9, by means of which the press 3 is activated. The illustration in FIG. 4 is highly simplified and is to only describe the basic principle. Only the drive of the actuators 5 in one direction can thus be seen from the figure. It is obvious for the person of skill in the art that further steps can be taken, so that the pressing rams 8 can be moved back again, for example.

The actuators 5 are activated via the pressure generator 4. A valve 10 is arranged between the pressure generator 4 and the actuators 5 or the working cylinders 6, respectively. Both actuators 5 can be activated separately or together via the valve 10.

A further valve 11 is arranged between the working cylinders 6. A hydraulic connection can be established between the working cylinders 5 via the valve 11. The valve 10 as well as the valve 11 are activated via the controller 9.

Pressing tools 12 are arranged at the pressing rams 8. A receptacle 13 in a die 14 is assigned to each pressing tool 12. Portions of food 2 are introduced into the receptacles 13, preferably so as to be frozen. After introducing the portions of food 2 into the receptacles 13, the valve 10 is activated such that pressure is applied to the working cylinders 6. Depending on the portion of food 2, which is expected, and on the deformation, which is to be attained in the respective receptacles, the actuators 5 are activated such that they are driven simultaneously or in a time-delayed manner. Preferably, the actuators 5 are activated such that the pressing rams 8 cover a predetermined distance in a first step. The sensors 15 inform the controller 9 about the distance, which the pressing rams 8 have covered, or the reaching of a position. In the alternative or in addition, the position can be determined via the flow of the hydraulic fluid, which is determined by means of the flow sensors 16, for example. If a defined position is passed, the valve 11 opens and a pressure compensation takes place between the working cylinders 6. All of the pressing tools 12 now move onto the portions of food 2 with the same pressure. If a portion of food 2, for example, is smaller than all of the other portions of food, which are arranged in the die, the pressing tool 12 moves deeper into the receptacle 13, until the same pressure is applied to all of the portions of food 2. It is ensured in this manner that of all of the portions of food 2 are deformed completely.

A flow sensor 17 monitors the flow between the working cylinders 6. If irregularities are determined, which could be associated with a disturbance, the controller 9 emits an alarm signal. The process step is furthermore ended and the pressing tools 12 move out of the receptacle again, when a defined maximum pressure was maintained for a certain period of time and wherein no flow or a flow below a defined threshold value was detected between the working cylinders 6 during that time.

### LIST OF REFERENCE NUMERALS

1 device
2 portion of food
3 press
4 pressure generator
5 actuator
6 working cylinder
7 piston
8 pressing ram
9 controller
10 valve
11 valve
12 pressing tool
13 receptacle
14 die
15 sensor
16 flow sensor
17 flow sensor

1. A device for forming portions of food comprising;
a fluid power press, wherein the press includes at least one fluid power pressure generator and at least two actuators, wherein each of the actuators includes a respective working cylinder,
wherein the working cylinders are connected by fluid power.

2. The device according to claim 1, further comprising:
a die that comprises at least two separate receptacles for receiving portions of food, wherein each of the receptacles is arranged to interact with a respective pressing tool, wherein the respective pressing tools are arranged to be moved by means of the respective actuators.

3. The device according to claim 1, further comprising at least one valve configured to control or regulate a flow between the working cylinders.

4. The device according to claim 1, further comprising at least one flow sensor arranged to determine a flow from and to at least one of the working cylinders.

5. The device according to claim 1, wherein the pressing tools are mechanically connected.

6. A method for forming portions of food, using the forming device according to claim 1, the method comprising:
introducing at least two portions of food into respective receptacles of a die,
placing at least one pressing tool for each receptacle of the die onto the respective portion of food, and
increasing force of the pressing tools on the portions of food such that all of the pressing tools exert a same pressure on the respective portions of food.

7. The method according to claim 6, wherein the working cylinders of the actuators, which operate the pressing tools, are connected by fluid power.

8. The method according to claim 6, wherein the pressing tools move a defined amount towards the die or move a defined amount into the receptacles, before the working cylinders are connected by fluid power.

9. The method according to claim 6, wherein the pressing tools are connected mechanically.

10. The method according to claim 9, further comprising releasing the mechanical connection between the pressing tools when the pressing tools move across a defined point.

11. The method according to claim 6, further comprising regulating a flow into the working cylinders and/or between the working cylinders as a function of at least one operating parameter of the forming device.

12. A portion of food produced using the method according to claim 6.
